(19) United States
(12) Patent Application Publication
(10) Pub. No.: US 2010/0271029 A1
(43) Pub. Date: Oct. 28, 2010

(54) Method and Device for Induced Polarization Mapping of Submarine Hydrocarbon Reservoirs

(76) Inventors: Eduard B. Fainberg, Amersfoort (NL); Pavel Barsukov, Amersfoort (NL); Jostein Kare Kjerstad, Stavanger (NO)

Correspondence Address: GABLE & GOTWALS, 100 WEST FIFTH STREET, 10TH FLOOR, TULSA, OK, 74103, US

(21) Appl. No.: 12/809,500

(22) PCT Filed: Dec. 15, 2008
(86) PCT No.: PCT/NO08/00446

§ 371 Date: Jul. 7, 2010

(30) Foreign Application Priority Data
Dec. 21, 2007 (NO) 20076602

(51) Int. Cl. G01V 3/08

(52) U.S. Cl. 324/334

(57) ABSTRACT

This invention is directed toward an electromagnetic surveying method based on detection of induced polarization effect and evaluation of its characteristics for mapping marine hydrocarbon targets. The method includes the steps of vertical deployment in a body of water of at least one electric wire which forms an electromagnetic transmitter which emits electromagnetic energy arranged to excite an electromagnetic field in the body of water and underlying medium, the same wire being used as a receiver for measurements of the vertical component of the electric field; (b) providing survey data as the spatial distribution of the vertical component of the electric field and the medium response in the form of apparent resistivity versus time in the body of water; (c) performing a space/time analysis of the vertical component of the electric field and response with the purpose of detecting induced polarization effect and determine its intensity and relaxation times; and (d) mapping the anomalous zones described by the characteristics perspective of the induced polarization for the exploration of an underground hydrocarbon reservoir. There is also described equipment for use when practising the method.

### CROSS-REFERENCE TO RELATED APPLICATIONS

This application is the United States National Phase of PCT Application No. PCT/NO2008/000446 filed 15 Dec. 2008 which claims priority to Norwegian Patent Application No. 20076602 filed 21 Dec. 2007. In addition Norwegian Patent Publication No. NO323889 is incorporated herein by reference.

### STATEMENT REGARDING FEDERALLY SPONSORED RESEARCH

Not Applicable

### NAMES OF THE PARTIES TO A JOINT RESEARCH AGREEMENT

Not Applicable

### REFERENCE TO A SEQUENCE LISTING

Not Applicable

### BACKGROUND OF THE INVENTION

The invention describes a method for fast direct mapping of the anomaly zones associated with hydrocarbon reservoirs below the seabed. The method is based on induced polarization effect observed in an electromagnetic field measured by vertical coinciding transmitter/receiver lines moving over subsea reservoirs.

At present two approaches are used for detecting and characterizing hydrocarbon-bearing reservoirs in deep-water areas.

The first approach is based on the sounding of a horizontally layered, electrically conductive section lying under a layer of sea water. This section represents the sediments. At some depth in these sediments is embedded a thin resistive reservoir containing hydrocarbons. The powerful transmitter excites alternating electric current in the layer of sea water and the underlying section, and one or multiple electric and/or magnetic recorders located at different sites on or above the seabed record(s) electromagnetic responses from the section. Images of these responses or their inversion and transformations are used, together with seismic data, logging data and other data, for oil and gas exploration as well as for reservoir assessment and development.

This approach has been described in numerous patents and methods, for example U.S. Pat. Nos. 4,617,518 and 6,522,146 of Srnka; U.S. Pat. No. 5,563,513 of Tasci; U.S. Pat. Nos. 52,685, 48,105, 6,628,119 of Eidesmo et al.; 2006132137 of MacGregor et al.; EP patent No. 1425612 of Wright et al.; international publication No. WO 03/048812 of MacGregor and Sinha, WO-2004049008; GB publication 2395563, AU publication 20032855 of MacGregor et al. and numerous other publications mentioned in the list of references which follows.

Such an approach can be used in the absence of so-called induced polarization effect (IP) which is capable of distorting the electromagnetic response of the structure containing a reservoir. In addition, this approach has a low resolution compared with seismic prospecting, the effectiveness thereby being relatively low.

The other approach is based on analysis on secondary electric fields arising under the impact of electric current transmitted in the section by a control source. These fields are of is an electrochemical nature and are caused by processes in so-called double layers arising at the contact between the solid substance of rocks and interstitial fluids. This effect is called induced polarization effect (IP).

The character of the IP depends on the electrical resistivity of the solid rock. In case hydrocarbons are present at the contact between resistive bearing strata, the IP processes are of an electro-kinetic character. The intensity of the IP effect depends on the electrolyte concentration and on the pore structure and can be used for hydrocarbon exploration.

IP effect is measured in either the time or the frequency domain.

In the time domain the transmitter excites series of electric current pulses of a rectangular shape with pauses between the pulses and recorders make measurements of the resultant electric fields in pauses between pulses. The IP effect manifests itself as a specific change in the time domain response which is present in the absence of IP effect.

In the frequency domain the transmitter generates alternating current of different frequencies, and recorders make measurements of responses. IP effect manifests itself as a reduction in voltage against an increase in frequency and a negative shift in voltage phase relative to the exciting current.

According to Kruglova et al. (1976) and Kirichek (1976) rocks lying in the reservoir area suffer epigene modifications under the influence of upward migration of hydrocarbons, which lead to changes in the chemical-mineralogical structure and physical properties of the rocks.

The other mechanism which creates IP effect has been discussed by Pirson (1969, 1976) and Oehler (1982) who explained it as the accumulation of pyrite in a shallow, porous host rock, where the pyrite is distributed within fractures or between original grains with a disseminated or cement-like texture.

Other models have been proposed for the explanation of IP effect, for example by Schumacher (1969). However, in all models the processes resulting in IP effect embrace huge volumes of rocks and can create anomalies not only in or close to the reservoirs but at different levels of section above the reservoirs.

Existing methods of hydrocarbon exploration based on the surveying of IP effect and US (Kaufman, 1978; Oehler, 1982; Srnka, 1986; Vinegar, 1988; Stanley 1995; Wynn, 2001; Conti, 2005) and Russian patents (Alpin, 1968; Belash, 1983; Kashik, 1996; Nabrat, 1997; Rykhlinksy, 2004; Lisitsin, 2006) cited above have been designed to detect electrochemically altered sediments, that is an alteration zone that may extend far upwards from the pyrite accumulation.

According to Moiseev (2002) a pyrite halo accompanying hydrocarbon deposits can be located at a depth of 300-700 metres independently of the deposit depth itself. Moiseev also noted that according to field investigations, a close relation between enhanced polarizability contours and hydrocarbon reservoir projection has been determined, which is indicative of vertical migration of hydrocarbons and gives the possibility of using this circumstance for hydrocarbon exploration.

At present there is little experience from the application of IP effect for marine hydrocarbon exploration; at the same time on-land experience has demonstrated that the exploration of hydrocarbon reservoirs was successful in seventy out of a hundred boreholes drilled on the basis of IP effect (Moiseev, 2002).

In experimental data the behaviour of the IP effect is usually described via different types of models representing the electric resistivity ρ of rocks as a frequency-dependent parameter. The dependence of the resistivity on frequency is of very great importance for hydrocarbon mapping because it provides a higher resolution with respect to parameters indicative of the existence of hydrocarbons.

An exhaustive review and analysis of existing models describing the dependence of resistivity on frequency, given by Dias (1968; 1972, 2000), demonstrated that IP effect can be appropriately expressed as:

$$ρ = {ρ}_{0} [ 1 - η ( 1 - 1 / t ϖ {τ}_{1} ( 1 + \frac{1}{μ} ) ) ] , \qquad ( 1 )$$

where

μ=tωτ+(tωτ₂)^{1/2}, τ=rC, τ₁=(R+R_{S})C, τ₂=(αC)², η=(ρ₀−ρ_{∞})/ρ₀.

Here τ, τ₁ and τ₂ are the relaxation times related to the different relaxation modes, ρ is the complex resistivity, ρ₀ and ρ_{∞} are the real values of ρ by direct current and highest is frequencies, respectively, η is the chargeability characterizing the intensity of the IP effect.

These 5 parameters (ρ₀, η, τ, τ₁, and τ₂) describe the frequency dependence of complex resistivity completely and can be used for petrophysical interpretation (Dias, 2000, Nelson et al., 1982, Mahan et al., 1986). The parameters r, R, RS, C, and α giving a phenomenological description of IP effect, are resistors, capacitor and some coefficient of equivalent circuit analogues (Dias, 2000). The relaxation times τ, τ₁ and τ₂ are closely connected with the separation between particles (sources of IP).

The well-known and popular Cole-Cole model has 4 parameters and is less precise than Dias's formula.

The complex character of ρ, which is typical of IP effect, considerably increases the sensitivity of electromagnetic fields to hydrocarbon targets and makes the method using IP effect as the indicator of hydrocarbons attractive for hydrocarbon mapping.

Kashik et al. (RU 2069375 CI, 1996), considered here as a precursor of the present invention, uses three vertical lines: one for a transmitter and two for receivers. All three of the lines are placed in different holes made in the ice floe. The transmitter generates pulse-shaped electric current, and receivers measure the vertical component of the electric field. The distance between the receiver lines in a horizontal direction is in the order of 1-2 times the prospecting depth. The difference between the amplitude of an electric field measured in two adjacent lines is used as the interpretive parameter. The disadvantage of this invention is the inability to control the movement of the ice floe, which highly decreases its possibilities and productivity; absence of measurements of the vertical component of the electric field at different levels in the sea, which limits the possibilities for noise suppression and interpretation.

### REFERENCES

| | | |
|---|---|---|
| Number | Publishing date | Applicant |

US PATENT PUBLICATIONS

| | | |
|---|---|---|
| 4114086 | December 1978 | Kaufman |
| 4360359 | November 1982 | Oehler |
| 4617518 | October 1986 | Srnka |
| 4743854 | May 1988 | Vinegar |
| 5444374 | August 1995 | Stanley et al. |
| 5563513 | October 1996 | Tasci |
| 6236212 | May 2001 | Wynn |
| 0052685 A1 | March 2003 | Ellingsrud et al. |
| 0048105 A1 | March 2003 | Ellingsrud et al. |
| 6628119 B1 | October 2003 | Eidesmo et al. |
| 6842006 | January 2005 | Conti et al. |
| 2006132137 | June 2006 | MacGregor et al. |

RUSSIAN PATENT PUBLICATIONS

| | | |
|---|---|---|
| SU 1122998 A | June 1983 | Belash |
| SU 266091 A1 | November 1968 | Alpin |
| RU 2069375 C1 | November 1996 | Kashik et al. |
| RU 2094829 C1 | October 1997 | Nabrat et al. |
| RU 2236028 C1 | September 2004 | Rykhlinsky et al. |
| RU 2253881 C1 | September 2006 | Lisitsin et al. |

OTHER PATENT PUBLICATIONS

| | | |
|---|---|---|
| WO 01/57555 A1 | September 2001 | Ellingsrud et al. |
| WO 02/14906 A1 | February 2002 | Ellingsrud et al. |
| WO 03/025803 A1 | March 2003 | Srnka et al. |
| WO 03/034096 A1 | Apirl 2003 | Sinha et al. |
| WO 03/048812 A1 | June 2003 | MacGregor et al. |
| WO 2004/049008 A1 | Apirl 2004 | MacGregor et al. |
| WO 2006/073315 | January 2006 | Johnstad et al. |
| EP 1425612 B1 | February 2006 | Wright et al. |

### OTHER PUBLICATIONS

Cole K. S., Cole R. H., 1941. Dispersion and absorption in the dielectrics. J. Chem. Phys. N9, pp. 341-351.
Dias, C. A., 1968. A non-grounded method for measuring electrical induced polarization and resistivity: Ph.D. thesis, Univ. California, Berkely.
Dias, C. A., 1972, Analytical model for a polarizable medium at radio and lower frequencies: J. Geophys. Res., 77, pp. 4945-4956.
Dias, C. A., 2000. Developments in a model to describe low-frequency electrical polarization of rocks. Geophysics, v. 65, N2, pp. 437-451.
Davydycheva S., Rykhlinsky N., Legeido P., 2006. Electrical prospecting method for hydrocarbon search using the induced-polarization effect. Geophysics, v. 71, N4, pp. G179-G189 (in Russian).
Eidesmo T., Ellingsrud S., MacGregor L. M., Constable S., Sinha M. C., Johansen S. E., Kong N., Westerdahl H., 2002. Sea Bed Logging (SBL), a new method for remote and direct identification of hydrocarbon filled layers in deepwater areas. First Break, 20, March, pp. 144-152.
Ellingsrud S., Sinha M. C., Constable S., MacGregor L. M., Eidesmo T., Johansen S. E., 2002. Remote sensing of hydrocarbon layers by Sea Bed Logging (SBL): Results from a cruise offshore Angola. The Leading Edge, 21, pp. 972-982.
Kirichek M. A., Korolkov Yu. S., Kruglova Z. D., 1976. Electrical surveying at direct prospecting for oil and gas deposits. In: Materials of VIII All-union research conference, Tumen-Moscow, pp. 5-7 (in Russian).
Kruglova Z. D., Anufriev A. A., Yakovlev A. P., 1976. On nature of induced polarization of oil deposits in PreCaspian depression. Prospecting Geophysics, issue 71, pp. 78-82 (in Russian).
Legeido P. Yu., Mandelbaum M. M., Rykhlinsky N. I., 1997. Self-descriptiveness of differential electrical prospecting methods at study of polarized media. Geophysics, Irkutsk, N3, pp. 49-56 (in Russian).
Legeido P. Yu., Mandelbaum M. M., Rykhlinsky N. I., 1999. Differential-normalized method of electrical prospecting. Geophysics, Irkutsk, Special issue, pp. 40-44 (in Russian).
MacGregor L., Sinha M., 2000. Use of marine controlled-source electromagnetic sounding for sub-basalt exploration. Geophysical prospecting, v. 48, pp. 1091-1106. MacGregor L., Sinha M., Constable S., 2001. Electrical resistivity of the Valu Fa Ridge, Lau Basin, from marine controlled-source electromagnetic sounding. Geoph. J. Intern., v. 146, pp. 217-236.
MacGregor L., Tompkins M., Weaver R., Barker N., 2004. Marine active source EM sounding for hydrocarbon detection. 66^{th} EAGE Conference & Exhibition, Paris, France, 6-10 Jun. 2004.
Mahan M. K., Redman J. D., Strangway D. W., 1986. Complex resistivity of synthetic sulphide bearing rocks. Geophys. Prospecting, v. 34, pp. 743-768.
Marine MT in China with Phoenix equipment, 2004. Published by Phoenix Geophysics Ltd., issue 34, pp. 1-2, December 2004.
Moiseev V. S., 2002. The method of induced polarization for oil prospective search. “Nauka”, Novosibirsk, p. 136 (in Russian).
Nabighian M. N., Macnae J. C., 2005. Electrical and EM methods, 1980-2005. The Leading Edge; 2005; v. 24, pp. S42-S45.
Nebrat A. G., Sochelnikov V. V., 1998. Electrical prospecting for polarized media by transient field method. Geophysics, N6, pp. 27-30 (in Russian).
Nelson P. H., Hansen W. H. and Sweeney M. J., 1982. Induced polarization response of zeolitic conglomerate and carbonaceous siltstone, Geophysics, v. 47, pp. 71-88.
Pelton W. H., Ward S. H., Hallof P. G., Sill W. R., Nelson P. H., 1978. Mineral discrimination and removal of inductive coupling with multi-frequency IP. Geophysics, 43, pp. 588-609.
Pirson, S. J., 1969, Geological, geophysical, and geochemical modification of sediments in the environments of oil fields, in W. B. Heroy, ed., Unconventional methods in exploration for petroleum and natural gas, symposium 1: Dallas, Tex., Southern Methodist University Press, pp. 159-186.
Pirson, S. J., 1976, Predictions of hydrocarbons in place by magneto-electrotelluric exploration: Oil and Gas Journal, May 31, pp. 82-86.
Thompson A. H., Sumner J. R., Hornbostel S. C., 2007. Electromagnetic-to-seismic conversion: A new direct hydrocarbon indicator. The Leading Edge, April, pp. 428-435.
Schumacher, D., 1996, Hydrocarbon-induced alteration of soils and sediments, In: D. Schumacher and M. A. Abrams, eds., Hydrocarbon migration and its near surface expression: AAPG Memoir 66, pp. 71-89.
Thompson A. H., Hornbostel S., Burns J., Murray T., Raschke R., Wride J., McCammon P., Sumner J., Haake G., Bixby M., Ross W., White B. S., Zhou M., Peczak P., 2007. Field tests of electroseismic hydrocarbon detection. Geophysics, v. 72, N1, pp. N1-N9. Tong M., Li L., Wang W., Jiang Y., 2006. A time-domain induced-polarization method for estimating permeability in a shaly sand reservoir. Geophysical Prospecting, v. 54, issue 5, pp. 623-631.
Yakubovsky Yu. V. Electrical Prospecting, M. Nedra, 1980, pp. 264-271 (in Russian).
Ulrich C., Slater L. D., 2004. Induced polarization measurements on unsaturated, unconsolidated sands. Geophysics, v. 69, N3, pp. 702-771.
Wynn J., Laurent K., 1998. A high resolution electrical geophysical approach to mapping marine sediments in the Atlantic coastal shelf and the Gulf of Mexico. SEG, Expanded Abstracts.

### BRIEF SUMMARY OF THE INVENTION

The present invention has for its object to remedy or reduce at least one of the drawbacks of the prior art.

The object is achieved through features which are specified in the description below and in the claims that follow.

The present invention provides a fast method of surveying for straightforward and fast determination of IP.

The present invention also provides a method for constructing and contouring an area through characterization by IP effect, thereby increasing the probability of detecting hydrocarbon reservoirs.

In addition, the present invention provides a method which enables the evaluation of some parameters which are useful for the petrophysical interpretation of rocks characteristic of hydrocarbon reservoirs potentially present in the area under surveying.

Further, the invention provides a method for processing the data recorded during is surveying, with the aim of determining parameters characterizing the petrophysical properties of the rocks creating the IP effect. These parameters are used for mapping by plane projection of reservoir edges on the seabed and together with CSEM, seismic, logging and other geological and geophysical methods for interpretation.

In a first aspect the invention relates more specifically to a method for electromagnetic surveying based on the detection of induced polarization effect and evaluation of its characteristics for mapping marine hydrocarbon targets, characterized by the method comprising:

a) deploying vertically in a water body at least one electrical wire forming an electromagnetic transmitter emitting electromagnetic energy which is arranged to excite an electromagnetic field in the water body and underlying medium, the same wire being used as a receiver for measurements of the vertical component of the electric field;
b) providing surveying data as the spatial distribution of the vertical component of the electric field and the medium response in the form of apparent resistivity versus time in the body of water;
c) carrying out a space/time analysis of the vertical component of the electric field and the response for the purpose of detecting induced polarization effect and determining its intensity and relaxation times; and
d) mapping the anomalous zones described by the characteristics perspective of the induced polarization effect for the exploration of an underground hydrocarbon reservoir. Through the supply of electromagnetic energy, one conductor of a vertically deployed multi-conductor cable is preferably used as an electromagnetic transmitter exciting an electromagnetic field in the body of water and underground medium, and other conductors in the cable, which are of different lengths and are terminated by electrodes, are used as receivers for measuring the medium response.

Advantageously, a plurality of vertically deployed multi-conductor cables, each having one conductor arranged for the supply of electromagnetic energy, are used as the electromagnetic transmitter exciting an electromagnetic field in the body of water and underlying medium, and other conductors in the cables, which are of different lengths and are terminated by electrodes, are used as receivers for measuring the medium response.

Preferably, one or a plurality of the receivers is/are fixed during measurements.

Preferably, one or a plurality of the receivers is/are towed by a vessel.

Preferably, the at least one transmitter emits electromagnetic energy in the time domain as an intermitted series of current pulses of different polarities and with sharp terminations, and at least one receiver makes measurements of time domain responses during time lapses between consecutive current pulses when the response is not masked by the transmitter current.

Preferably, the duration of the current pulses and pauses is specified in such a way that an electromagnetic field penetration depth is provided, exceeding two to three times or more the depth at which the reservoir is located, preferably within a range of 0.1 seconds to 30 seconds.

In a second aspect the invention relates more specifically to a surveying apparatus for the electromagnetic surveying of marine hydrocarbon targets, characterized by one or more generators, which are arranged to generate current pulses of different polarities with sharp terminations, being connected to a submersible system comprising: at least one electrical wire which is arranged to emit electromagnetic energy into a body of water and an underlying medium, and is arranged to receive the vertical component of the electric field, at least one of the electrical wires being a vertically deployed multi-conductor cable in which at least one conductor is arranged to excite, when being supplied with electromagnetic energy from a generator, an electromagnetic field in the body of water and the underlying medium, and other conductors of the cable, which are of different lengths and are terminated by electrodes, are arranged to receive the vertical component of the electric field for registration of the medium response.

In a third aspect the invention relates to a surface vessel characterized by it carrying a surveying apparatus in accordance with the appended claim 8.

In a fourth aspect the invention relates to a computer apparatus loaded with machine-readable instructions for the implementation of the method for an electromagnetic survey in accordance with any one of the appended claims 1 to 7.

### BRIEF DESCRIPTION OF THE DRAWINGS

In what follows is described a non-limiting example of a preferred embodiment which is visualized in the accompanying drawings, in which:

FIGS. 1a-1c illustrate the possible configurations usable for fast IP mapping of potential hydrocarbon-containing areas;

FIGS. 2a and 2b present the result of numerical modelling with curves of apparent resistivity versus time for different sections with and without IP effect; and

FIG. 3 illustrates the possible strategy for hydrocarbon surveying.

### DETAILED DESCRIPTION OF THE INVENTION

In a first exemplary embodiment a single transmitter mounted on a vessel consists of a vertically deployed, elongated, conductive single-core cable terminated by electrodes, which is submerged in a body of water. The vessel is moving slowly, and the transmitter emits intermittent current pulses which have sharp terminations, while the same cable with electrodes is used for measurements of medium responses in the course of time lapses between consecutive current pulses. This is described further in NO323889 which is incorporated herein in its entirety as reference.

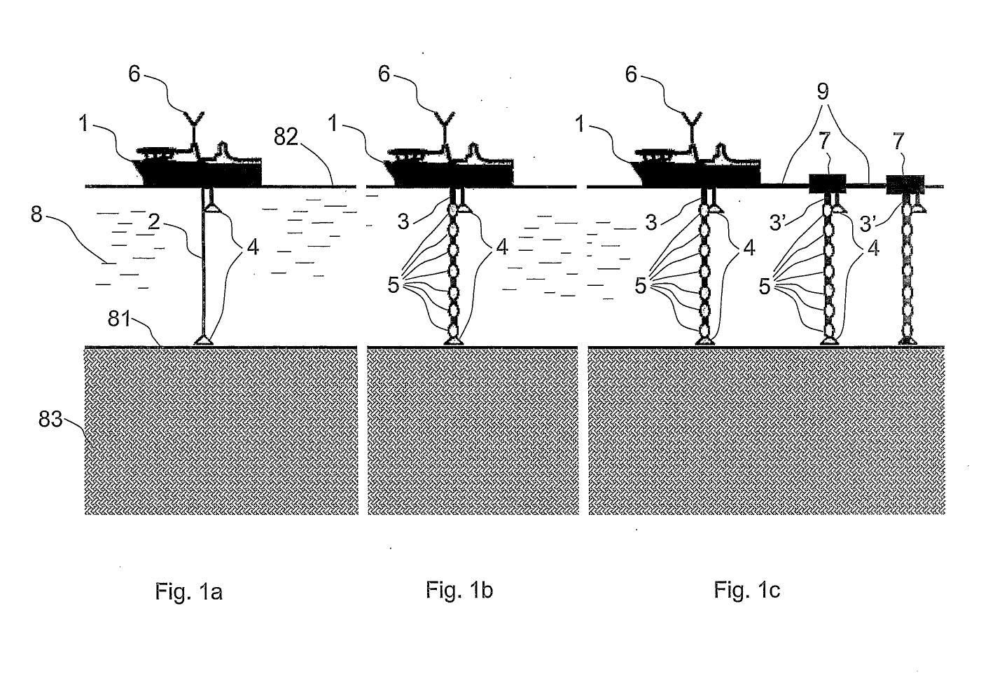

The first exemplary embodiment is illustrated in FIG. 1a, in which a vessel 1 floating on a water surface 82 is towing a vertical elongated cable 2 terminated by electrodes 4, said cable 2 being submerged in a body of water 8 towards a seabed 81. A generator (not shown) is installed on the vessel 1 and is arranged to emit intermittent current pulses, which have sharp terminations, into the cable 2. The cable 2 with the electrodes 4 is arranged to register the response from an underlying medium 83, that is, the underground is structure which is the object of the mapping, in the course of the pause between two pulses. A position monitoring system 6 is used for determining the position of the vessel 1 during the survey.

In a second exemplary embodiment a generator is installed on the vessel and is connected to a vertically deployed, elongated multi-core conductive cable including electrodes, which is submerged in the body of water. The vessel is moving slowly in a horizontal direction and the transmitter emits, on one of the conductors of the cable, intermittent current pulses having sharp terminations, whereas the others of the conductors of the cable, which are of different lengths and are terminated by electrodes, are used for measurements of the medium responses at different distances from a seabed in the course of time lapses between consecutive current pulses. Such a configuration makes it possible to suppress the influence of local inhomogeneities near the seabed and increase the accuracy of the response determination and its interpretation.

The second exemplary embodiment is illustrated in FIG. 1b, in which the vessel 1 is towing a vertically elongated multi-conductor cable 3 submerged in the body of water 8. One of the conductors (not shown) of the cable 3, which are terminated by electrodes 4, is connected to a generator (not shown) as a source of intermittent current. Other cable conductors (not shown) terminated by non-polarized electrodes 5 form a recording system for measurements of the responses of the medium at different levels in the water body 8. A position-monitoring system 6 is used for determining the position of the vessel 1 at surveying.

In a third exemplary embodiment a plurality of transmitters are installed on the vessel and on associated buoys behind the vessel 1 in the form of vertically deployed, elongated multi-core conductive cables terminated by electrodes, which are submerged in a body of water, the transmitter cable configuration corresponding to what has been described for the second exemplary embodiment above. The vessel moves slowly in a horizontal direction and each of the transmitters emits, on the core of one cable, intermittent sharp-termination current pulses, whereas each of the other cores of the cables, which are of different lengths and are terminated by electrodes, is used for measurements of the medium responses at different distances from the seabed during the time lapses between consecutive current pulses. Such a configuration gives the possibility of stacking the signals, suppressing the influence of local inhomogeneities near the seabed which produce separation of deep-lying IP targets complicated by IP effect, and increasing the accuracy in response determination and interpretation.

The third exemplary embodiment is illustrated in FIG. 1c, in which the vessel 1 is towing a vertically deployed, elongated first multi-conductor cable 3 which is submerged in the body of water 8. In addition, by means of a towing rope 9 the vessel 1 tows one or more vertical, elongated second multi-conductor cables 3′ suspended from buoys 7 and submerged in the body of water 8. One of each of the conductors (not shown) of the multi-conductor cables 3, 3′ terminated by electrodes 4 is connected to a generator (not shown) as a source of intermittent current. The others of the conductors (not shown) of the multi-conductor cables 3, 3′ are terminated by non-polarized electrodes 5 for measurements of the medium responses at different distances from the seabed and different distances from the vessel 1. A position-monitoring system 6 is used for the determination of the positions of the ship 1 and buoys 7 during surveying.

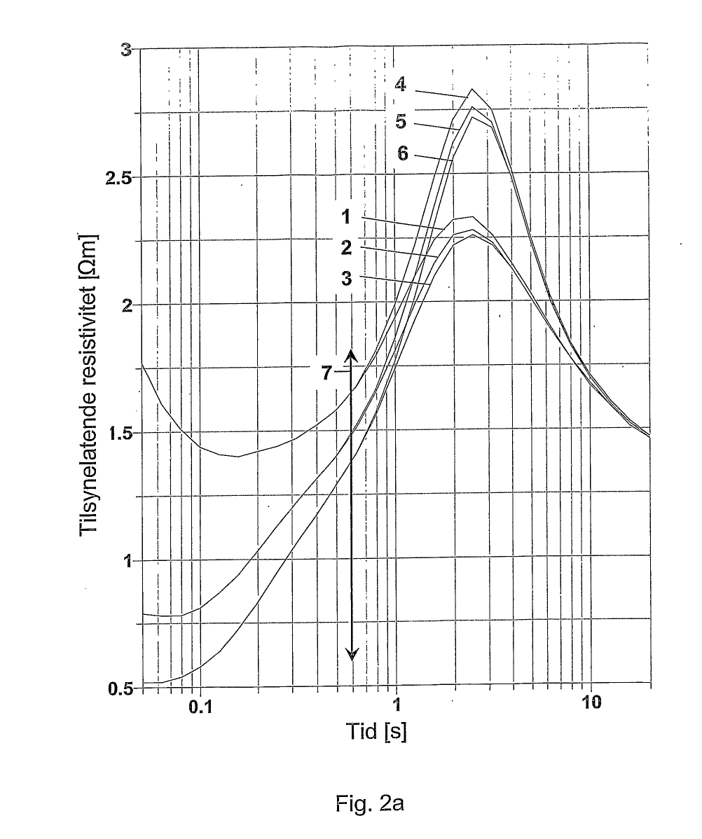

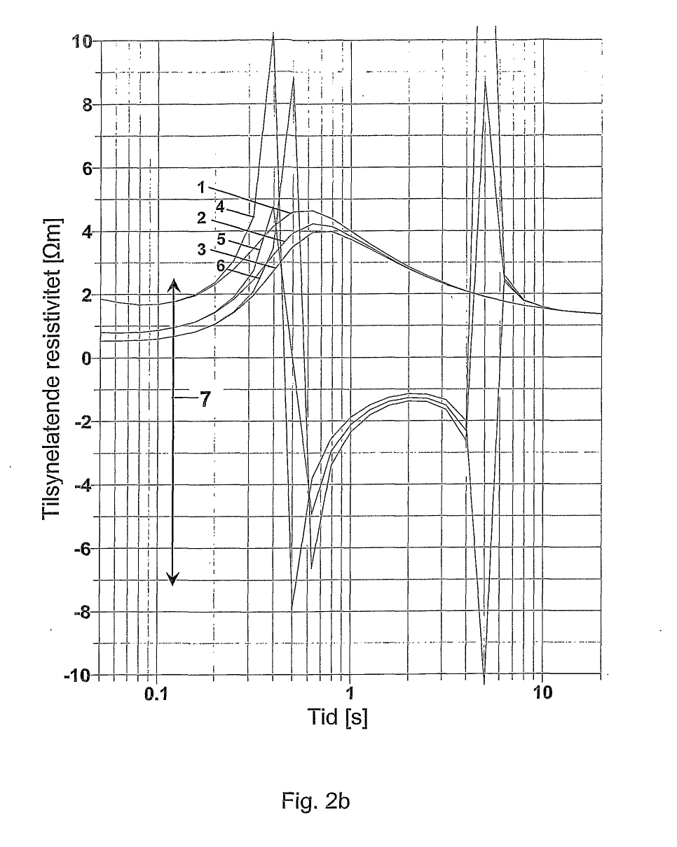

FIGS. 2a and 2b illustrate the possibility of distinguishing between IP effects originating from shallow and deep targets. Parameters of the sections are:

### FIG. 2a:

h₁=300 m,
ρ₁=0.3 Ωm (sea water),
h₂=1000 m,
ρ₂=1 Ωm (sediments),
h₃=50 m,
ρ₃=40 Ωm (hydrocarbon layer),
P₄=1 Ωm.

The curves 1, 2, 3 relate to a model without IP effect and the curves 4, 5, 6 relate to a model with IP effect (chargeability m=0.1).

### FIG. 2b:

h₁=300 m,
ρ₁=0.3 Ωm (sea water),
h₂=300 m,
ρ₂=1 Ωm (sediments),
h₃=50 m,
ρ₃=40 Ωm (hydrocarbon layer),
P₄=1 Ωm.

The curves 1, 2, 3 relate to a model without IP effect and the curves 4, 5, 6 relate to a model with IP effect (chargeability m=0.1).

The length of the transmitter line 2 is 300 m and the receiver line coincides with the transmitter line 2, 3, 3′ and has a length equaling 1 m. The distance of the receiver line from the seabed is 0 m (curves 1, 4), 100 m (curves 2, 5) and 300 m (curves 3, 6), respectively.

A vertical line 7 marks the beginning of IP effect (t=0.6 s in FIG. 2a and t=0.11 s in FIG. 2b).

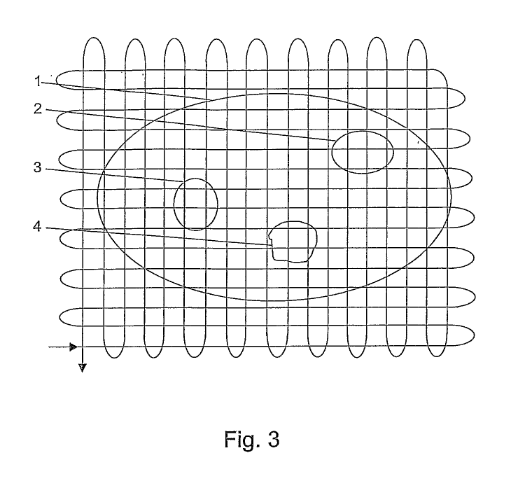

In FIG. 3 the arrows indicate the start and end points of the surveying; and the reference numerals 1-4 are contours of IP effect intensity anomalies.

According to the first exemplary embodiment of the present invention only one line is used, forming a vertical, coinciding set-up of the transmitter and receiver (FIG. 1a). Such a set-up provides maximum sensitivity in the electromagnetic field with respect to the resistive hydrocarbon target. The vertical component of the electric field has maximum sensitivity to the resistive targets (reservoirs). In addition the coincidence of the transmitter and receiver lines provides maximum amplitude in the measured IP fields.

In another configuration of the present invention are used a plurality of receiver lines of different lengths in the form of conductors in the multi-conductor cables 3 which coincide with a single transmitter line (FIG. 1b). The longer away the receiver lines are from the seabed 81, the less sensitive they are for shallow-lying responding media. A spatial analysis of a vertical electric field measured at different levels gives the possibility of distinguishing between IP effects created by responding media near the seabed and deeper-lying responding media and to estimate the depth of the responding media.

A simple estimation of the depth of the responding media creating IP effect can be made by the use of a time delay t₀ (vertical line 7 in FIGS. 2a and 2b) for the beginning of IP effect: tₛ^{ip}≈0.6 s—see FIG. 2a, and tₛ^{ip}≈0.1 s—see FIG. 2b. The penetration depth h of an electromagnetic field in a uniform medium is h=\sqrt{10⁷ρt₀/2π} metres; the depth of the model in FIGS. 2a and 2b equals approximately 1000 m, respectively 400 m, close to real values, that is. There are different ways of determining the time delay, for example response measured from the area with IP effect, or construction of the response by the use of independent section parameters characterized by the absence of IP effect.

Still another configuration of the present invention consists of a plurality of vertical transmitter and multi-core receiver lines 3, 3′ spaced apart horizontally, deployed at different distances from the seabed (FIG. 2c), which gives the possibility of suppressing the influence of shallow-lying inhomogeneities creating local IP anomalies. The system of spatially distributed measurements is, in some cases, able to provide information on a depth of the targets creating IP effect.

The preferred configuration of the present invention which provides high performance of surveying is a plurality of transmitters and receiver 3, 3′ which are towed by the vessel 1. The vessel 1 is stopped from time to time and/or works in a start-stop regime.

A comparison of the present invention with Kashik et al. (RU 2069375 CI, 1996) shows that the possibility of using coincident lines 3, 3′ for the transmitter and receivers and space-time measurements of the vertical component of the electric field simultaneously at different levels and in different locations as the vessel 1 is moving, provides principally new possibilities for mapping promising areas and searching for hydrocarbon areas.

Another advantage of the present invention is the way of determining the interpretation parameters ρ₀, η, τ, τ₁, and τ₂ which are inserted into the formula (I). These parameters are determined by a two-step procedure:
1) transformation of the measured vertical, electric field into apparent resistivity ρ^{e};
2) evaluation of interpretive parameters from minimum of functional

$${\sum }_{n = 1}^{N} {\sum }_{m = 1}^{M} {w}_{mm} \vert {ρ}_{nm}^{e} - {ρ}_{nm}^{c} \vert \qquad ( 2 )$$

Here ρₙₘ^{e} is the measured apparent resistivity relevant for the n-th time sample at the m-th location; N and M are the total number of time samples, respectively locations, ρₙₘ^{c} is the result of direct problem solution for some electrical model of the medium containing a target producing IP effect; wₘₙ is the weight of the ρₙₘ^{e} sample allowing accuracy of data, a priori geological and geophysical information etc.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

1. An electromagnetic surveying method based on the detection of induced polarization effect and evaluation of its characteristics for mapping marine hydrocarbon targets, characterized in that the method comprises:
a) deploying vertically in a body of water (8) at least one electrical wire (2, 3, 3′) forming a first-mentioned electromagnetic transmitter which emits electromagnetic energy which is arranged to excite an electromagnetic field in the body of water (8) and underlying medium (83), the same wire (2, 3, 3′) being used as a first-mentioned receiver for measurements of the vertical component of the electric field;
b) providing survey data as the spatial distribution of the vertical component of the electric field and the medium response in the form apparent resistivity versus time in the body of water (8);
c) performing a space/time analysis of the vertical component of the electric field and response with the aim of detecting induced polarization effect and determining its intensity and relaxation times; and
d) mapping the anomalous zones described by the characteristics perspective of the induced polarization effect for the exploration of an underground hydrocarbon reservoir.

2. The method according to claim 1 wherein the first-mentioned receiver is stationary during measurements.

3. The method according to claim 1 wherein the first-mentioned receiver is towed by a vessel (1).

4. The method according to claim 1 wherein the first-mentioned transmitter emits electromagnetic energy in the time domain as an intermitted series of current pulses of different polarities and with sharp terminations, and the first-mentioned receiver makes measurements of time domain responses during time lapses between consecutive current pulses when the response is not masked by the transmitter current.

5. The method according to claim 4 wherein the duration of the current pulses and pauses is specified in such a way that there is provided a penetration depth for the electromagnetic field exceeding at least two times the depth at which the reservoir is located.

6. The method according to claim 4 wherein the duration of current pulses and pauses is in a range of 0.1 seconds to 30 seconds.

7. The method according to claim 1 including utilizing at least one conductor of a vertically deployed multi-conductor cable (3, 3′), when supplied with electromagnetic energy, as a second-mentioned electromagnetic transmitter exciting an electromagnetic field in the body of water (8) and underlying medium (83), and utilizing other conductors of the cable (3, 3′), which are of different lengths and are terminated by electrodes (5), as second-mentioned receivers for measurements of the medium response.

8. The method according to claim 7 wherein at least one of the second-mentioned receivers is stationary during measurements.

9. The method according to claim 7 wherein at least one of the second-mentioned receivers is towed by a vessel.

10. The method according to claim 7 wherein the second-mentioned transmitter emits electromagnetic energy in the time domain as an intermitted series of current pulses of different polarities and with sharp terminations, and at least one of the second-mentioned receivers make measurements of time domain responses during time lapses between consecutive current pulses when the response is not masked by the transmitter current.

11. The method according to claim 10 wherein the duration of the current pulses and pauses is specified in such a way that there is provided a penetration depth for the electromagnetic field exceeding at least two times the depth at which the reservoir is located.

12. The method according claim 10 wherein the duration of current pulses and pauses is in a range of 0.1 seconds to 30 seconds.

13. A surveying apparatus for the electromagnetic surveying of marine hydrocarbon targets, characterized in that one or more generators arranged to generate current pulses of different polarities with sharp terminations is/are connected to a submersible system comprising:
at least one electrical wire (2, 3, 3′) which is arranged to emit electromagnetic energy in a body of water (8) and an underlying medium (83) and is arranged to receive the vertical component of the electric field, at least one of the electrical wires (3, 3′) being a multi-conductor cable (3, 3′) deployed vertically, at least one conductor being arranged to excite, when supplied with electromagnetic energy from a generator, an electromagnetic field in the body of water (8) and the underlying medium (83), and other conductors in the cable (3, 3′), which are of different lengths and are terminated by electrodes (5), being arranged to receive a vertical component of the electric field for registration of the medium response.
